(19) United States
(12) Patent Application Publication
(10) Pub. No.: US 2026/0044348 A1
(43) Pub. Date: Feb. 12, 2026

(54) NON-BLOCKING UNIT STRIDE VECTOR INSTRUCTION DISPATCH WITH MICRO-OPERATIONS

(71) Applicant: Akeana, Inc., Santa Clara, CA (US)

(72) Inventors: Hai Ngoc Nguyen, Redwood City, CA (US); Abhijit Sil, Dublin, CA (US); Rabin Sugumar, Sunnyvale, CA (US)

(73) Assignee: Akeana, Inc., Santa Clara, CA (US)

(21) Appl. No.: 19/342,743

(22) Filed: Sep. 29, 2025

Related U.S. Application Data
(63) Continuation-in-part of application No. 19/290,518, filed on Aug. 5, 2025.
(60) Provisional application No. 63/679,685, filed on Aug. 6, 2024.
(60) Provisional application No. 63/687,795, filed on Aug. 28, 2024.
(60) Provisional application No. 63/690,822, filed on Sep. 5, 2024.
(60) Provisional application No. 63/691,351, filed on Sep. 6, 2024.
(60) Provisional application No. 63/699,245, filed on Sep. 26, 2024.
(60) Provisional application No. 63/702,192, filed on Oct. 2, 2024.
(60) Provisional application No. 63/714,529, filed on Oct. 31, 2024.
(60) Provisional application No. 63/719,841, filed on Nov. 13, 2024.
(60) Provisional application No. 63/730,997, filed on Dec. 12, 2024.
(60) Provisional application No. 63/735,937, filed on Dec. 19, 2024.
(60) Provisional application No. 63/745,432, filed on Jan. 15, 2025.
(60) Provisional application No. 63/764,198, filed on Feb. 27, 2025.
(60) Provisional application No. 63/765,094, filed on Feb. 28, 2025.
(60) Provisional application No. 63/777,814, filed on Mar. 26, 2025.
(60) Provisional application No. 63/795,829, filed on Apr. 28, 2025.
(60) Provisional application No. 63/797,195, filed on Apr. 30, 2025.
(60) Provisional application No. 63/803,977, filed on May 12, 2025.
(60) Provisional application No. 63/831,282, filed on Jun. 27, 2025.
(60) Provisional application No. 63/844,802, filed on Jul. 16, 2025.
(60) Provisional application No. 63/854,877, filed on Jul. 31, 2025.
(60) Provisional application No. 63/870,916, filed on Aug. 27, 2025.

(51) Int. Cl. G06F 9/38; G06F 9/30

(52) U.S. Cl. CPC G06F 9/3836; G06F 9/30036; G06F 9/3004; G06F 9/30145

(57) ABSTRACT

Disclosed techniques enable vector instruction processing. A processor core is accessed. The processor core is coupled to a memory hierarchy, and is configured to execute vector operations, scalar operations, and micro-operations. A decode unit decodes a vector memory operation. The vector memory operation is associated with a unit stride addressing mode. The decoding includes dividing the vector memory operation into one or more vector memory micro-operations. A dispatch unit sends at least one vector micro-operation within the one or more vector micro-operations to a scalar request queue within a plurality of request queues. The at least one vector micro-operation is issued to a load-store unit within the processor core. The issuing includes selecting, from the plurality of request queues, the at least one vector memory micro-operation.

### RELATED APPLICATIONS

This application claims the benefit of U.S. provisional patent applications “Non-Blocking Unit Stride Vector Instruction Dispatch With Micro-Operations” Ser. No. 63/702,192, filed Oct. 2, 2024, “Non-Blocking Vector Instruction Dispatch With Micro-Element Operations” Ser. No. 63/714,529, filed Oct. 31, 2024, “Vector Floating-Point Flag Update With Micro-Operations” Ser. No. 63/719,841, filed Nov. 13, 2024, “Shadow Stack Management With Micro-Operations” Ser. No. 63/730,997, filed Dec. 12, 2024, “Systolic Array Matrix-Multiply Accelerator With Row Tail Accumulation” Ser. No. 63/735,937, filed Dec. 19, 2024, “Non-Flushing Vector Micro-Operations With VSET” Ser. No. 63/745,432, filed Jan. 15, 2025, “Precalculated Routing Information In A Coherent Mesh Network” Ser. No. 63/764,198, filed Feb. 27, 2025, “Transformed Activation Function With ISA Extension” Ser. No. 63/765,094, filed Feb. 28, 2025, “Vector Unit With An Activation Function Accelerator Pipeline” Ser. No. 63/777,814, filed Mar. 26, 2025, “Accelerated TAGE Branch Prediction With A TAGE Cache” Ser. No. 63/795,829, filed Apr. 28, 2025, “Branch Prediction With Next Program Counter Caches” Ser. No. 63/797,195, filed Apr. 30, 2025, “Weight-Stationary Matrix Multiply Acceleration With A Prefilled Memory Hierarchy” Ser. No. 63/803,977, filed May 12, 2025, “Single Cycle Move Instruction Elimination With Multiple Dependencies In A Dispatch Bundle” Ser. No. 63/831,282, filed Jun. 27, 2025, “In-Order Multithreading With Dispatch Bundle Packing” Ser. No. 63/844,802, filed Jul. 16, 2025, “AI Compute Clusters With Noncoherent Shared SRAM” Ser. No. 63/854,877, filed Jul. 31, 2025, and “In-Order Multithreading With Pipeline Flush And Instruction Replay” Ser. No. 63/870,916, filed Aug. 27, 2025.

This application is also a continuation-in-part of U.S. patent application “Non-Blocking Vector Instruction Dispatch With Micro-Operations” Ser. No. 19/290,518, filed Aug. 5, 2025, which claims the benefit of U.S. provisional patent applications “Non-Blocking Vector Instruction Dispatch With Micro-Operations” Ser. No. 63/679,685, filed Aug. 6, 2024, “Atomic Compare And Swap Using Micro-Operations” Ser. No. 63/687,795, filed Aug. 28, 2024, “Atomic Updating Of Page Table Entry Status Bits” Ser. No. 63/690,822, filed Sep. 5, 2024, “Adaptive SOC Routing With Distributed Quality-Of-Service Agents” Ser. No. 63/691,351, filed Sep. 6, 2024, “Communications Protocol Conversion Over A Mesh Interconnect” Ser. No. 63/699,245, filed Sep. 26, 2024, “Non-Blocking Unit Stride Vector Instruction Dispatch With Micro-Operations” Ser. No. 63/702,192, filed Oct. 2, 2024, “Non-Blocking Vector Instruction Dispatch With Micro-Element Operations” Ser. No. 63/714,529, filed Oct. 31, 2024, “Vector Floating-Point Flag Update With Micro-Operations” Ser. No. 63/719,841, filed Nov. 13, 2024, “Shadow Stack Management With Micro-Operations” Ser. No. 63/730,997, filed Dec. 12, 2024, “Systolic Array Matrix-Multiply Accelerator With Row Tail Accumulation” Ser. No. 63/735,937, filed Dec. 19, 2024, “Non-Flushing Vector Micro-Operations With VSET” Ser. No. 63/745,432, filed Jan. 15, 2025, “Precalculated Routing Information In A Coherent Mesh Network” Ser. No. 63/764,198, filed Feb. 27, 2025, “Transformed Activation Function With ISA Extension” Ser. No. 63/765,094, filed Feb. 28, 2025, “Vector Unit With An Activation Function Accelerator Pipeline” Ser. No. 63/777,814, filed Mar. 26, 2025, “Accelerated TAGE Branch Prediction With A TAGE Cache” Ser. No. 63/795,829, filed Apr. 28, 2025, “Branch Prediction With Next Program Counter Caches” Ser. No. 63/797,195, filed Apr. 30, 2025, “Weight-Stationary Matrix Multiply Acceleration With A Prefilled Memory Hierarchy” Ser. No. 63/803,977, filed May 12, 2025, “Single Cycle Move Instruction Elimination With Multiple Dependencies In A Dispatch Bundle” Ser. No. 63/831,282, filed Jun. 27, 2025, “In-Order Multithreading With Dispatch Bundle Packing” Ser. No. 63/844,802, filed Jul. 16, 2025, and “AI Compute Clusters With Noncoherent Shared SRAM” Ser. No. 63/854,877, filed Jul. 31, 2025.

Each of the foregoing applications is hereby incorporated by reference in its entirety.

### FIELD OF ART

This application relates generally to vector processing and more particularly to non-blocking unit stride vector instruction dispatch with micro-operations.

### BACKGROUND

Modern electronic devices and products base their performance and functionality directly on the processors within them. Indeed, processor efficiency applies to products across many industries. Processor efficiency enables faster, more responsive systems, facilitating applications which demand rapid response times, including gaming, real-time processing, and high-performance computing. Further, efficient processors consume less power, thereby extending portable device battery life and lowering data center energy costs, which are key for sustainability and environmental impacts. Additionally, efficient processors dissipate less heat, enabling thermal management in laptops, servers, and embedded systems. Thermal management prevents overheating and maintains stable device operation. Efficiency supports sleek, compact designs, especially for mobile devices, wearables, and IoT devices where size and weight matter. Overall, efficient processors save costs in manufacturing and operations, reduce electricity expenses, and enable smaller cooling solutions, leading to further savings.

Foremost processor categories include Complex Instruction Set Computer (CISC) types and Reduced Instruction Set Computer (RISC) types. In a CISC processor, one instruction may execute several operations. The operations can include storing to and reading from memory, arithmetic and logical operations, and so on. In contrast, in a RISC processor, the instruction sets tend to be smaller than the instruction sets of CISC processors. Instructions may be executed in a pipelined manner using pipeline stages that may include fetch, decode, and execute. Each of these pipeline stages may take one clock cycle to complete. Thus, the pipelined operation can allow RISC processors to operate on more than one instruction per clock cycle.

Integrated circuits (ICs) such as processors can be designed using a Hardware Description Language (HDL). Example HDLs can include Verilog, VHDL, etc. HDLs enable the description of behavioral, register transfer, gate, and switch level logic. These descriptions provide designers with the ability to define these levels of abstraction in detail. Behavioral level logic enables a set of instructions to be executed sequentially, while register transfer level logic allows the transfer of data between registers, driven by an explicit clock and gate level logic. The HDL can be used to create human-readable text models that describe or express logic circuits. The models can be processed by a synthesis program, followed by a simulation or emulation program to test the logic design. Part of the process may include Register Level Transfer (RTL) abstractions that define the synthesizable data that is fed into a logic synthesis tool, which in turn creates the gate-level abstraction of the design that is used for downstream implementation operations.

Processor efficiency is crucial to performance, power use, and user experience in modern products. As technology advances, there is an increased focus on creating processors that balance high performance with energy efficiency to cater to the diverse needs of different applications and industries.

### SUMMARY

Processor instruction sets, such as RISC processor instruction sets, can include scalar instructions, which can be called scalar operations, and vector instructions, which can be vector operations. Scalar instructions/operations may operate on individual data points, and may use general-purpose registers for data storage. Scalar operations are often used in branching and control instructions. Vector instructions/operations can operate on multiple data elements simultaneously. Vector instructions may utilize dedicated vector registers, allowing for operations on entire arrays. Vector instructions can serve to increase throughput by performing the same operation across data sets with fewer instructions. Extensions such as vector operation extensions can be enabled for a processor architecture such as a RISC-V processor core. Vector operations can, with a single instruction, require many individual operations to complete the single instruction. For example, vector operations such as vector multiplication, vector addition, vector dot product, vector cross product, and so on can involve several steps and complex operations to accurately compute the result of the vector operation being executed. One step can include operand preparation. This step can include alignment of one or more vectors. In some exemplary implementations, the alignment of the one or more vectors can be based on a unit stride, where the unit can include a byte, a word, and so on

Disclosed techniques enable vector processing. A processor core is accessed. The processor core is coupled to a memory hierarchy, and is configured to execute vector instructions, scalar operations, and micro-operations. A decode unit decodes a vector memory operation. The vector memory operation is associated with a unit stride addressing mode. The decoding includes dividing the vector memory operation into one or more vector memory micro-operations. A dispatch unit sends at least one vector micro-operation within the one or more vector micro-operations to a scalar request queue within a plurality of request queues. The at least one vector micro-operation is issued to a load-store unit within the processor core. The issuing includes selecting, from the plurality of request queues, the at least one vector memory micro-operation.

A processor-implemented method for vector processing is disclosed comprising: accessing a processor core, wherein the processor core is coupled to a memory hierarchy, and wherein the processor core is configured to execute vector operations, scalar operations, and micro-operations; decoding, by a decode unit, a vector memory operation, wherein the vector memory operation is associated with a unit stride addressing mode, wherein the decoding includes dividing the vector memory operation into one or more vector memory micro-operations; sending, by a dispatch unit, at least one vector micro-operation within the one or more vector micro-operations, to a scalar request queue within a plurality of request queues; and issuing, to a load-store unit within the processor core, the at least one vector micro-operation, wherein the issuing includes selecting, from the plurality of request queues, the at least one vector memory micro-operation. In embodiments, the dividing is based on a destination register. In embodiments, the vector memory operation comprises a vector load operation. In embodiments, the scalar request queue comprises a load request queue (LRQ). In embodiments, the vector memory operation comprises a vector store instruction. In embodiments, the scalar request queue comprises a store request queue (SRQ).

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for non-blocking unit stride vector instruction dispatch with micro-operations.

FIG. 2 is a flow diagram for selecting from request queues.

FIG. 3 is an example of accessing memory with unit stride addressing.

FIG. 4 is a block diagram of a multicore processor.

FIG. 5 is a block diagram of a pipeline.

FIG. 6 is a block diagram for dispatching instructions.

FIG. 7 is an example of dispatching vector and scalar operations.

FIG. 8 is a system diagram for non-blocking unit stride vector instruction dispatch with micro-operations.

### DETAILED DESCRIPTION

The overall capacity, flexibility, and utility of a device such as a personal electronic device directly depends on the performance of the one or more processors within the device. Processors are found in a wide range of devices including mobile devices, wearables, consumer electronics, automotive systems, smart home systems, edge computing, and IoT devices. Efficient pipelines including instruction pipelines are essential to processor performance, particularly in processors such as RISC processors. The instruction pipelines within processors can be designed to handle vector operations, where the vector operations can be broken into micro-operations. The micro-operations can then be executed, where the execution of the micro-operations can include out-of-order execution. Efficient pipelines can enable multiple micro-operations to execute concurrently, thereby increasing instruction execution throughput. By dividing operation execution into stages, each stage can be optimized for specific tasks, resulting in enhanced, faster processing.

Operation processing that uses a pipeline, or “pipelining,” reduces the amount of time required to execute a series of micro-operations. The processing time is reduced by providing the micro-operations to the pipeline. This technique enables the processor to initiate processing of a next operation before the processing of the previous operation has completed. Overlapping the execution time of individual operations results in faster overall program execution. The increased processor performance attributable to sequencing of the micro-operations can occur when an operation exploits instruction-level parallelism (ILP). The ILP enables multiple instructions or operations to be simultaneously in various stages of execution. Furthermore, efficient pipelines help maintain a steady flow of operations through the processor, reducing the likelihood of operation stalls or bottlenecks. A seamless flow of operations to the processor ensures that the processor can consistently perform at or near its peak capabilities. This can be especially important in processors that implement vector operations.

In one or more exemplary implementations, the actual vector operation can be performed using hardware components including, but not limited to, pipelines dedicated to vector operations. In some exemplary implementations, an iterative or algorithmic approach may be used to execute the vector operation. Vector registers in a processor are designed to efficiently handle operations on multiple data elements simultaneously. These registers enable a single instruction to operate on multiple data elements, which is particularly beneficial for tasks that involve large datasets and parallel processing. The vector registers can support addition and/or subtraction of corresponding elements of two vectors, producing a new vector as the result. Additionally, other operations, including, but not limited to, vector multiplication, vector division, vector dot product, vector shifts, and/or other operations can be supported with vector registers. Furthermore, the vector operations can include vector load and store operations to enable loading data from memory into the register or storing data from the register back to memory. The loading and storing can be based on a unit stride. A vector operation can be executed by decoding a vector operation into a series of micro-operations associated with a unit stride addressing mode. At least one vector micro-operation is sent to a scalar request queue within a plurality of request queues. The at least one vector micro-operation is issued to a load-store unit within the processor core. The issuing includes selecting the at least one vector memory micro-operation from the plurality of request queues. The scalar request queue can be coupled to a micro-operation sequencer. The micro-operation sequencer can generate a series of micro-operations based on an input vector memory instruction. Concurrently, scalar memory operations can be routed to respective scalar load queues and/or scalar store queues.

While the pipelining in RISC architectures can improve performance, a mix of scalar and vector instructions (including vector instructions that have been divided into multiple vector micro-operations) can create stalls in a processor pipeline. Pipeline stalls lead to a reduction in the overall instruction throughput, thereby slowing program execution. Each stalled cycle adds latency, delaying the completion of instructions. Moreover, pipeline stages are left idle during stalls, leading to inefficient use of CPU resources. In particular, since a vector instruction can take longer to process than a scalar operation, processing of a vector operation in the dispatch stage of processing could potentially create a situation where scalar operations are waiting to enter the pipeline, causing a bottleneck. Disclosed techniques address the aforementioned issues of bottlenecks caused by vector instructions by enabling non-blocking unit stride vector instruction dispatch. Disclosed techniques further disclose additional queues for storing vector instructions, and processing of vector instructions created by a decode unit. A reorder buffer identification (ROBID) parameter is used to ensure that instructions do not age within a queue prior to dispatch and that all instructions are retired in order, while still supporting out-of-order (OoO) execution.

Techniques for non-blocking vector instruction dispatch with micro-operations are disclosed. A processor architecture, such as a multiprocessor architecture, can include one or more pipelines. A processor instruction pipeline can include at least a fetch stage, an align/decode stage, and a dispatch stage, among other stages. The decode stage can decode an operation such as a vector memory operation. The vector memory operation can be associated with a unit stride addressing mode, where the unit stride addressing mode indicates a separation or stride between data elements in the memory. The decoding stage can divide the vector memory operation into one or more vector memory micro-operations. The dispatch stage can maintain a reorder buffer (ROB). The ROB, which can be based on a circular buffer, can keep track of, and keep in order, all “in flight” instructions. Pointers, such as a head pointer and a tail pointer, can be associated with the ROB. The oldest instruction can be pointed to by the head pointer, while the newest instruction can be pointed to by the tail pointer. New instructions are added at the tail of the ROB. Thus, the ROB indicates an arrival order of instructions in the dispatch stage. The dispatch stage can send at least one vector micro-operation to a scalar request queue within a plurality of request queues. The at least one vector micro-operation can be issued to a load-store unit within the processor core for execution.

An execution stage can follow the dispatch stage. The ROB is used to ensure proper sequencing and retiring of instructions. The retiring can include successfully completing the execution, and writing of results of the instruction back to the register file and/or memory. The dispatch unit can maintain a reorder buffer identifier (ROBID) that is used to ensure that instructions are completed in the correct program order, while still supporting an out-of-order instruction architecture.

Execution of vector instructions/operations can be complex because the vector instructions operate on multiple data elements. One technique for handling the complexity of these instructions is to split a vector operation into multiple micro-operations. The dividing can be accomplished by a decode unit associated with the processor. However, because multiple instructions (micro-operations) now replace a single instruction in the processor pipeline, pipeline stalls can occur. In a usage example, a vector operation can be fetched, decoded, and assigned a reorder buffer identification (ROBID) by the dispatch unit. A decode unit within the processor can split the vector operations into the vector micro-operations. Thus, all of the micro-operations can be assigned the same ROBID in order to preserve the correct architectural state during writeback. However, the dispatch unit can handle multiple vector instructions in addition to any scalar operations that were fetched and decoded. This situation can create a delay in dispatching a scalar operation which may have a ROBID later than the micro-instructions associated with the vector operation. This event can cause a scalar pipeline stall which can result in reduced overall processor performance.

Disclosed techniques enable concurrent processing of vector instructions and scalar operations to reduce the probability of a pipeline stall and improve overall processor performance. In disclosed techniques, the dispatch unit can assign a ROBID and can divide vector instructions based on a unit stride into one or more micro-operations. The micro-operations from the vector instructions based on a unit stride can be routed to a scalar request queue. Scalar operations can also be routed to a scalar request queue. The scalar request queue can include a load request queue (LRQ) and/or a store request queue (SRQ). Vector instructions that are based on an indexed stride or on a constant stride can also be broken into micro-operations. Those micro-operations can then be routed to a vector input queue. The vector input queue can include a vector load input queue (VLIQ) and/or a vector store input queue (VSIQ). The VLIQ and the VSIQ can further divide the micro-operation instructions based on an indexed stride or on a constant stride into one or more micro-element memory operations (MEMOs). Thus, the dispatch unit is not taxed with managing as many instructions and instruction flows to the vector pipeline. Similarly, scalar operations, once assigned a ROBID, can be routed to their respective request queues, such as a scalar load request queue (LRQ), and/or a scalar store request queue (SRQ). A multiplexor (mux) is configured to receive scalar and vector instructions for a given type (load or store). The ROBID is used for mux control to feed the proper instruction to a downstream pipeline stage. Thus, complexity can be removed from the dispatch unit and instructions can be sent immediately to their respective pipelines unimpeded. In this way, the disclosed processor-implemented techniques can provide improvements in the pipelined processing of a mix of scalar and vector instructions, thereby improving overall processor performance for a variety of vector-intensive applications.

Vector-intensive applications can include scientific computing applications such as simulations and numerical analysis that involve matrix operations. The vector-intensive applications can include graphics processing applications that perform tasks such as rendering images and animations, where operations on pixels or vertices are common. The vector-intensive applications can include signal processing applications, such as audio and video processing, where filtering and transformations are frequent. The vector-intensive applications can further include language analysis and processing such as natural language processing applications. Accordingly, disclosed techniques support these and other vector-intensive applications by enabling concurrent processing of scalar operations and vector operations, while reducing the probability of pipeline stalls.

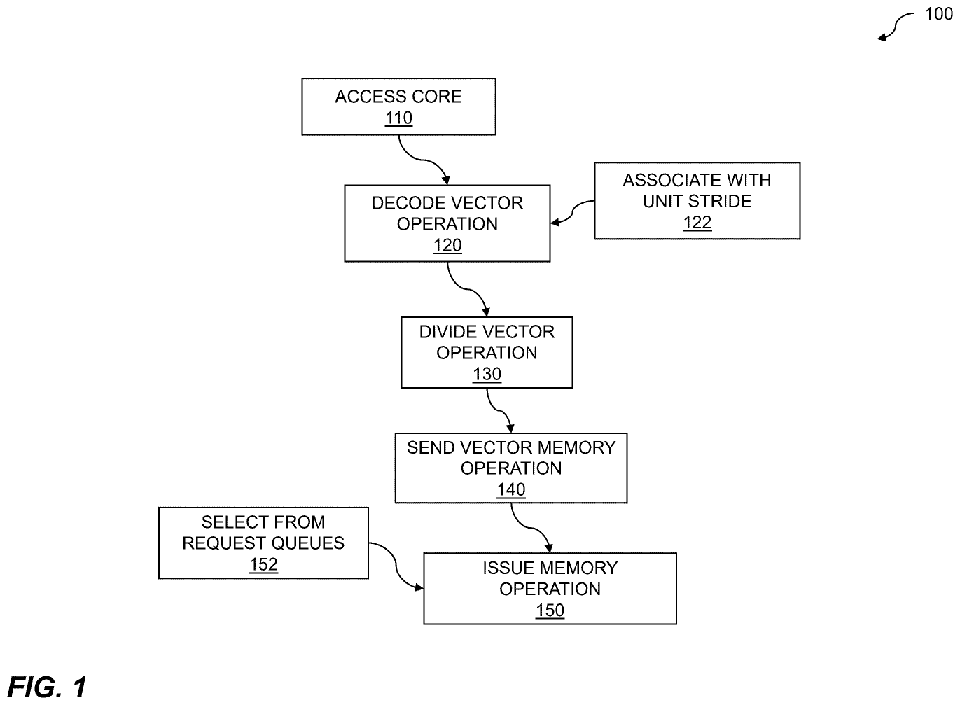

FIG. 1 is a flow diagram for non-blocking unit stride vector instruction dispatch with micro-operations. The flow 100 includes accessing a processor core 110. The processor core can be included on a multi-processor chip, an application specific integrated circuit (ASIC), a system-on-a-chip (SOC), and so on. The processor core can execute instructions that are part of an instruction set architecture (ISA) such as RISC, X86, ARM, and so on. In embodiments, the processor core is coupled to a memory hierarchy. The memory hierarchy can include a local cache, a shared cache, and so on. The cache can include a multilevel cache, where the multilevel cache can include L1, L2, L3, etc. caches. The memory hierarchy can include memory such as dynamic random access memory (DRAM), synchronous dynamic random access memory (SDRAM), and so on. The memory hierarchy can be coherent or non-coherent. In embodiments, the processor core is configured to execute vector operations, scalar operations, and micro-operations. The micro-operations can comprise a series of less complex instructions, which when executed can perform the operation of a single, more complex instruction. A micro-operation sequencer can be used for vector instructions/operations, scalar operations, floating point operations, and so on. Vector instructions (also called vector operations) can be executed by the processor within a dedicated vector pipeline, while scalar operations can be executed by a scalar pipeline. When the vector instruction is associated with a stride such as a unit stride, micro-operations associated with the unit stride vector instruction can be executed by the scalar pipeline. The processor can include other instruction pipelines, such as a floating-point pipeline.

The flow 100 includes decoding 120, by a decode unit, a vector memory operation. The vector memory instruction or operation can include an instruction for data movement. Data movement instructions can include load and/or store operations for transferring data between memory and registers. In embodiments, the vector memory operation can include a vector load operation. In other embodiments, the vector memory operation can include a vector store instruction. The registers can include scalar registers and vector registers. The sizes of scalars supported by the instruction and the sizes of vectors supported by the instruction can vary. The vector sizes supported by the instructions can include multiples of 16 bits and can include 64-bit sizes, 128-bit sizes, 256-bit sizes, 512-bit sizes, and/or other suitable sizes. In the flow 100, the vector memory operation can be associated with a stride 122. A processor core such as a RISC-V processor core can support one or more strides for accessing data. The stride can include an indexed stride, a constant stride, a unit stride, and so on. In embodiments, the vector memory operation that is decoded is associated with a unit stride addressing model. In the flow 100, the decoding can include dividing 130 the vector memory operation into one or more vector memory micro-operations. The dividing a vector operation can be based on a decision. The dividing can be based on an operation type, an amount of data, and so on. The deciding can be based on opcodes that are indicative of an instruction being a scalar type of instruction or a vector type of instruction. The deciding can be based on a known complexity of the instruction that was received. The deciding can include combinational logic, a content addressable memory (CAM), a lookup table, a state machine, and so on. In embodiments, the dividing can be based on a destination register. The destination register can include a register associated with the processor core. In embodiments, the dividing can be accomplished by a micro-operation sequencer. For vector operations based on a unit stride, the micro-operation sequencer can be an element within the decode unit. For vector operations based on an indexed stride or a constant stride, additional dividing can occur within a vector queue (discussed below).

The flow 100 includes sending 140, by a dispatch unit, at least one vector micro-operation within the one or more vector micro-operations to a scalar request queue within a plurality of request queues. The scalar request queues can include one or more queues. The queue to which the vector micro-operation is sent depends on the memory operation performed by the micro-operation. In embodiments, the scalar request queue can include a load request queue (LRQ). More than one LRQ can be associated with the processor core. In other embodiments, the scalar request queue can include a store request queue (SRQ). Similarly, more than one SRQ can be associated with the processor core. Since the processor core can also process vector memory operations based on indexed strides and/or constant strides, further request queues can be accessible to the dispatch unit. In embodiments, the plurality of request queues includes a vector load request queue (VLQ). More than one VLQ can be accessible to the processor core. In further embodiments, the plurality of request queues can include a vector store request queue (VSQ). More than one VSQ can be accessible to the processor core.

The vector operation can be assigned a reorder buffer ID (ROBID). The assigning can occur within the dispatch unit. The instructions such as micro-operations within the processor can be executed in an out-of-order fashion. The ROBID can be used to ensure instructions are retired in order. The instructions can be executed out of order based on resource capabilities and availability. The retiring the executed instructions in order ensures that data is routed correctly. Discussed previously and throughout, the vector memory operation is associated with a memory addressing mode. The memory addressing mode can comprise a unit stride addressing mode. In a unit stride addressing mode, data can be arranged in memory such that each successive access is adjacent to the previous access, which can be particularly well suited for vector processing and/or array manipulations. For a unit stride, successive memory accesses can be adjacently located (that is, the stride between memory accesses is one). Other strides can be supported. The memory addressing mode can include a constant stride addressing mode. In a constant stride addressing mode, data can be arranged in memory such that each successive access is a constant number of bytes apart. The memory addressing mode can include an indexed stride addressing mode. The indexed stride addressing mode can combine a base address with an index and a stride to access memory locations.

The flow 100 includes issuing 150, to a load-store unit within the processor core, the at least one vector micro-operation. The load-store unit can access a memory, where the memory can include a local cache, a shared cache such as a shared multi-level cache, a shared memory system, and so on. The at least one vector micro-operation can be sent from an LRQ or from an SRQ. The issuing can further include issuing a vector operation such as a vector load operation. In embodiments, the vector load operation within the VLQ can include a load of a single vector element. The issuing can further include issuing a vector store operation. In embodiments, the vector store operation within the VSQ can include a store of a single vector element. In the flow 100, the issuing includes selecting 152, from the plurality of request queues, the at least one vector memory micro-operation. The selecting can be accomplished using multiplexers (muxes). The selecting can include selecting a scalar operation or a vector micro-operation in a scalar queue, and a vector micro-operation in a vector queue. In embodiments, the selecting can include choosing between a vector load instruction within the VLQ and the at least one vector memory micro-operation within the LRQ.

Vector load operations associated with index stride and constant stride accesses can be complex to implement. Thus, in these instances, a separate vector element micro-operation sequencer can be included within a vector load input queue VLIQ or a vector store input queue (VSIQ) prior to the VLQ and VSQ. The vector element micro-operation sequencer can further divide the vector micro-operation, which is based on a destination register, into one or more vector element micro-operations, which can be based on elements of the vector within the destination register. For example, a vector load instruction can be associated with a constant stride addressing mode. Based on control registers, the vector load instruction may send data into four different destination registers. In practice, the vector load may send data into any number of destination registers based on one or more control registers and/or the vector load instruction itself. In this case, the micro sequencer within the decode unit can replace the vector load instruction with four vector load micro-operations, based on the four destination registers. These vector load micro-operations can flow to the vector load input queue (VLIQ). If each vector load micro-operation operates on four vector elements (e.g., four vector loads are performed per destination register), then the vector element micro sequencer within the VLIQ can replace the four vector load micro-operations with 16-vector-element micro-operations. In practice, any number of vector load micro-operations can be created, based on one or more control registers and/or the original vector load instruction. In this example, with 16-vector-element micro-operations now filling the vector load queue, another vector memory operation can become blocked from being dispatched to one or more load-store units. Thus, disclosures enable vector memory operations associated with a unit stride, which can be divided into one or more vector micro-operations, to be sent to a scalar queue for faster processing.

The choosing can be based on one or more of parameters, control signals, a code, and so on. In embodiments, the choosing can be based on a reorder buffer identification (ROBID). In other embodiments, the selecting can include choosing between a vector store operation within the VSQ and the at least one vector memory micro-operation within the SRQ. As for the selecting a load operation, the selecting a store operation can be based on parameters, control signals, codes, etc. In embodiments, the choosing can be based on a reorder buffer identification (ROBID).

One or more exemplary implementations can support concurrent execution of multiple micro-operations, yielding a higher instruction throughput. In one or more examples, the micro-operations can be executed out of order. The micro-operations can include instructions to cause the processor to load data from a cache within a cache hierarchy into an element of a vector register.

In some embodiments, the ROBID indicates an oldest instruction within the plurality of memory queues. The choosing can be accomplished with one or more multiplexors (muxes). The muxes can be controlled with a control signal that is based on an instruction type associated with a lowest ROBID value. When the lowest ROBID value indicates a scalar operation, the mux can be configured to select from a memory queue utilized for scalar operations. Similarly, when the lowest ROBID value indicates a vector instruction, the mux can be configured to select from a memory queue utilized for vector instructions. In one or more examples, the ROBID can be implemented as a sequentially incrementing counter. In one or more examples, rollover logic can be implemented to handle the case of the counter rolling over to continue proper instruction operation. The rollover logic can include detection, where the ROBID value is monitored for overflow. When the ROBID reaches a maximum value (e.g., (0xFFFFFFFF), it rolls over to zero on the next increment. The rollover logic can ensure that any logic dependent on the counter value can handle the wraparound from the maximum value back to zero. One or more examples may accomplish this by utilizing unsigned integer arithmetic. In embodiments, the ROBID rolls over to zero on the next increment when it reaches a maximum value.

Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors. Various embodiments of the flow 100, or portions thereof, can be included on a semiconductor chip and implemented in special purpose logic, programmable logic, and so on.

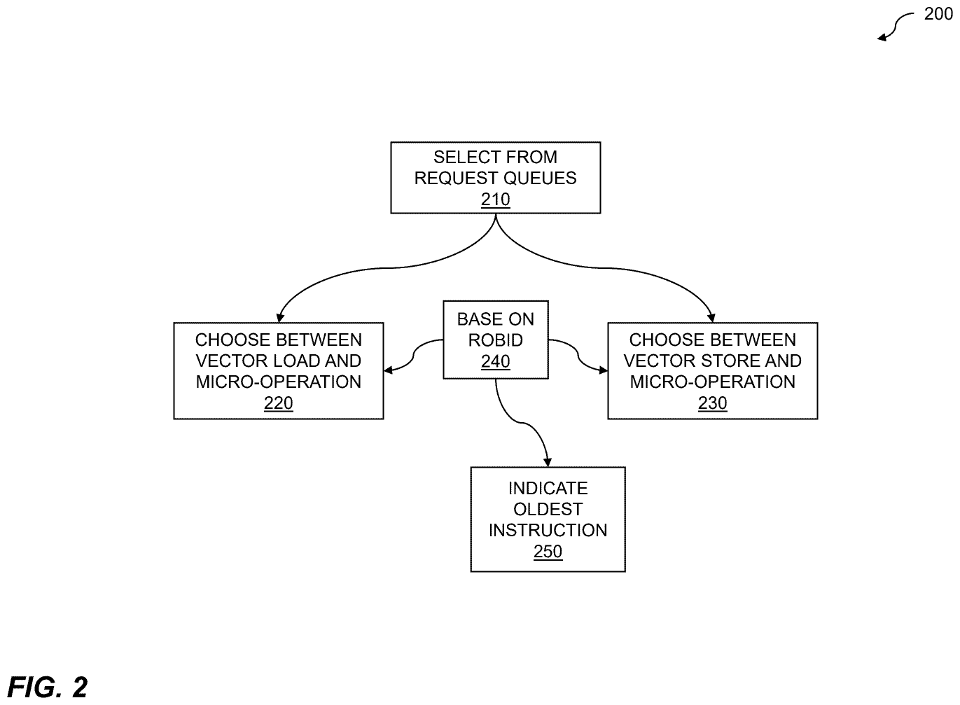

FIG. 2 is a flow diagram for selecting from request queues. The memory queues can include scalar memory instruction load queues and store queues. The memory queues can further include vector memory input load queues and store queues. The scalar load queues and the scalar store queues can include scalar operations and vector micro-operations, where the vector micro-operations were divided from vector memory instructions based on unit stride. The vector load queues and the vector store queues can include vector memory element micro-operations based on vector instructions that were associated with indexed strides and constant strides. The selecting from memory queues enables non-blocking unit stride vector instruction dispatch with micro-operations. A processor core is accessed, wherein the processor core is coupled to a memory hierarchy, and wherein the processor core is configured to execute vector operations, scalar operations, and micro-operations. A decode unit decodes a vector memory operation, wherein the vector memory operation is associated with a unit stride addressing mode, wherein the decoding includes dividing the vector memory operation into one or more vector memory micro-operations. A dispatch unit sends at least one vector micro-operation within the one or more vector micro-operations to a scalar request queue within a plurality of request queues. The at least one vector micro-operation is issued to a load-store unit within the processor core, wherein the issuing includes selecting, from the plurality of request queues, the at least one vector memory micro-operation.

The flow 200 includes selecting, from the plurality of request queues 210, the at least one vector memory micro-operation. As explained above, a scalar memory operation, a vector memory operation, or one or more vector memory micro-operations can be dispatched to any one of a number of memory queues. These memory queues can include scalar memory queues and vector memory queues. The scalar memory queues can include a load request queue (LRQ), a scalar store request queue (SRQ), etc. Micro-operations that are divided from a vector memory instruction based on a unit stride can be dispatched to a queue within the scalar memory queues. The vector memory queues can include a vector load queue (VLQ), a vector store queue (VSQ), and so on. Recall that vector memory instructions that are based on an indexed stride or a constant stride can be dispatched to the vector memory queues. The vector memory operations based on an indexed stride or a constant stride within the VLQ and/or VSQ can comprise vector element micro-operations that were split by an additional micro-operation sequencer in a prior stage (the VLIQ and VSIQ, respectively). Memory instructions that have been forwarded to one of the memory queues can indicate that the instruction is ready to be sent to an execution pipeline, such as a load-store pipeline. The load-store pipeline can be associated with a load-store unit.

In embodiments, selecting can include choosing between a vector load operation within the VLQ and the at least one vector memory element micro-operation within the LRQ 220. The selecting can determine whether a load within the LRQ, which can include a vector load micro-operation associated with a unit stride addressing mode, or a vector load within the VLQ, is sent to the load-store unit for execution. The vector load instruction within the VLQ can include a vector load micro-operation associated with a unit stride addressing mode. In the flow 200, the selecting can include choosing between a vector store operation within the VSQ and the at least one vector memory micro-operation within the SRQ 230. In this case, the selecting can determine whether a store instruction within the SRQ, which can include a vector store micro-operation associated with a unit stride addressing mode, or a vector store instruction within the VSQ, is sent to the load-store unit for execution. Any instruction, once sent to the load-store unit, can be processed out of order. The out-of-order processing can result from compiler optimizations, resource utilization issues, dependency delays, and so on.

In the flow 200, the choosing is based on a reorder buffer identification (ROBID) 240. The ROBID can be associated with a vector instruction, a scalar operation, one or more micro-operations, one or more vector element micro-operations, and so on. In further embodiments, the ROBID indicates an oldest instruction 250 within the plurality of memory queues. An older instruction can be indicated by a lower ROBID. As explained above, the choosing can be accomplished with one or more multiplexers (muxes). The muxes can be controlled with a control signal that is based on an instruction type associated with a lowest ROBID value. In disclosed examples, the instruction associated with the lowest ROBID is the oldest instruction, and is the instruction that can be issued first. The issued instruction can load or store scalar data or vector data. In embodiments, the ROBID indicates an oldest instruction within the plurality of memory queues. In one or more examples, rollover logic can be implemented to handle the case of the counter rolling over, thereby enabling continuation of proper instruction operation. The rollover logic can include detection, where the ROBID value can be monitored for overflow or underflow.

Various steps in the flow 200 may be changed in order, repeated, omitted, or the like without departing from the disclosed concepts. Various embodiments of the flow 200 can be included in a computer program product embodied in a non-transitory computer readable medium that includes code executable by one or more processors. Various embodiments of the flow 200, or portions thereof, can be included on a semiconductor chip and implemented in special purpose logic, programmable logic, and so on.

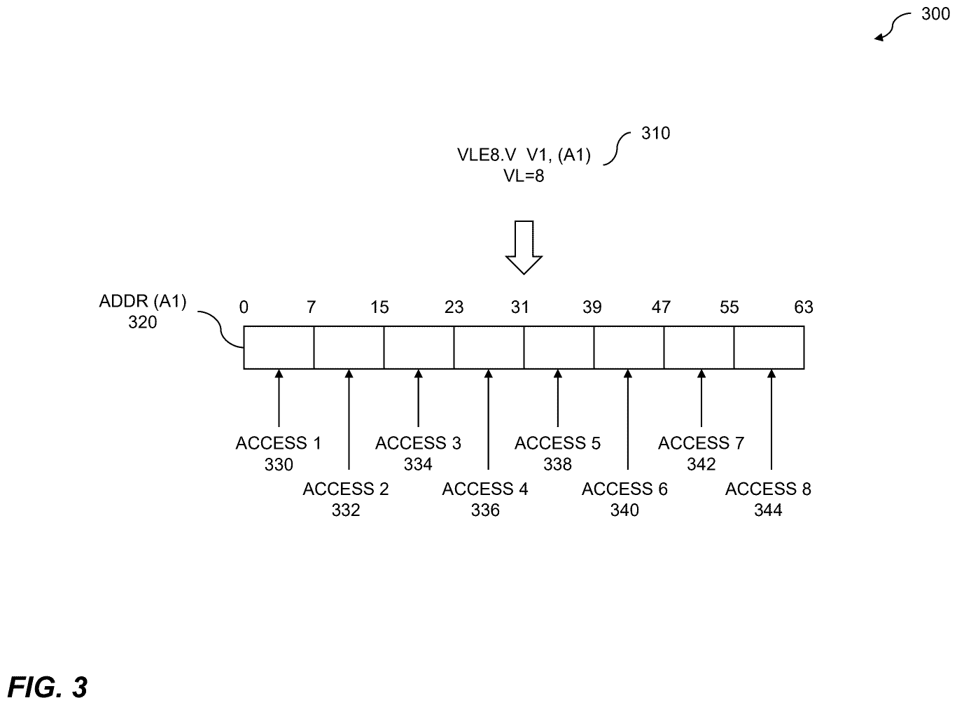

FIG. 3 is an example of accessing memory with unit stride addressing. Discussed previously and throughout, a vector memory instruction can include a vector memory load instruction, a vector memory store instruction, and so on. The vector memory instructions can be based on a stride, where the stride can include an indexed stride, a constant stride, or a unit stride. A vector memory instruction based on a unit stride can be divided into one or more micro-operations, where the one or more micro-operations can be dispatched to a scalar load request queue or a scalar store request queue. The micro-operations and the scalar operations can be intermixed within the scalar request queues. Unit stride vector instruction dispatch with micro-operations enables non-blocking processing. A processor core is accessed, wherein the processor core is coupled to a memory hierarchy, and wherein the processor core is configured to execute vector operations, scalar operations, and micro-operations. A decode unit decodes a vector memory operation, wherein the vector memory operation is associated with a unit stride addressing mode, wherein the decoding includes dividing the vector memory operation into one or more vector memory micro-operations. A dispatch unit sends at least one vector micro-operation within the one or more vector micro-operations to a scalar request queue within a plurality of request queues. The at least one vector micro-operation is issued to a load-store unit within the processor core, wherein the issuing includes selecting, from the plurality of request queues, the at least one vector memory micro-operation.

In the example 300, a vector memory load instruction, VLE8.V V1, (A1) is shown 310. The vector load instruction is a vector load 8-byte instruction that loads data into vector register V1. The data is loaded from an address that is referenced in a general-purpose register. The data is loaded from the address ADDR in general-purpose register A1, ADDR (A1) 320. A control register, VL, is shown which indicates that the vector element length is 8. Thus a 64-bit word that is accessed in 8-bit (1 byte) segments is shown. The segments include access 1 330, access 2 332, access 3 334, access 4 336, access 5 338, access 6 340, access 7 342, and access 8 344.

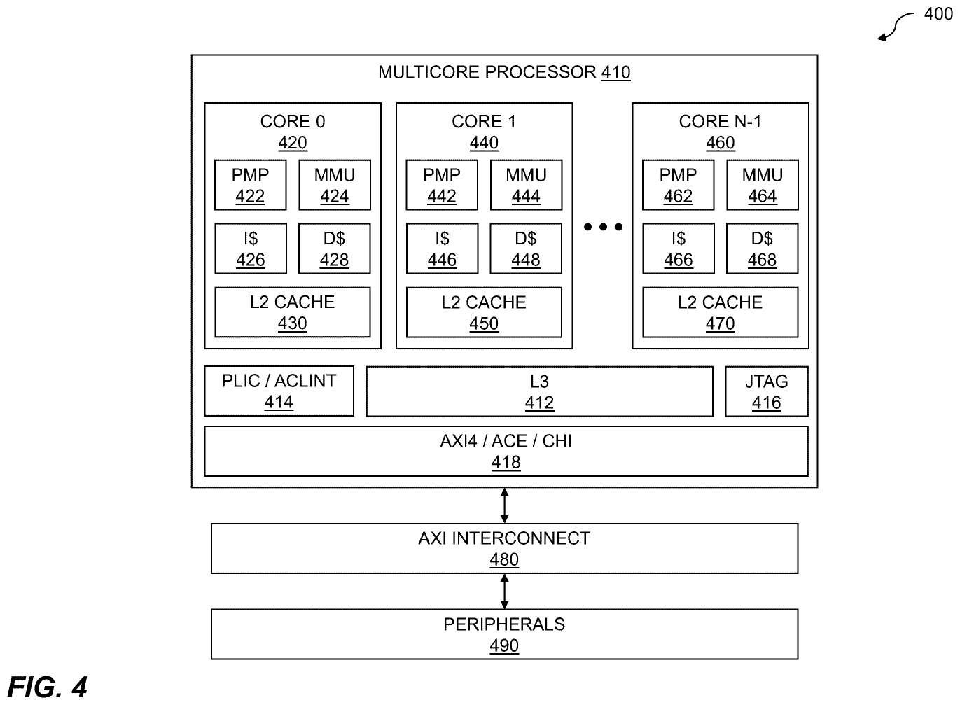

FIG. 4 is a block diagram of a multicore processor. The processor, such as a RISC-V™ processor, an ARM processor, or other suitable processor type, can include a variety of elements. The elements can include processor cores including multiprocessor cores, one or more caches including local caches and shared caches, memory protection and management units, local storage, and so on. In one or more exemplary implementations, the processor core enables non-blocking unit stride vector instruction dispatch with micro-operations. The elements of the multicore processor can further include one or more of a private cache; a test interface such as a joint test action group (JTAG) test interface; one or more interfaces to a network such as a network-on-chip, shared memory, and peripherals; and the like. A processor core is accessed, wherein the processor core is coupled to a memory hierarchy, and wherein the processor core is configured to execute vector operations, scalar operations, and micro-operations. A decode unit decodes a vector memory operation, wherein the vector memory operation is associated with a unit stride addressing mode, wherein the decoding includes dividing the vector memory operation into one or more vector memory micro-operations. A dispatch unit sends at least one vector micro-operation within the one or more vector micro-operations, to a scalar request queue within a plurality of request queues. A load-store unit within the processor core issues the at least one vector micro-operation, wherein the issuing includes selecting, from the plurality of request queues, the at least one vector memory micro-operation.

In the block diagram 400, the multicore processor 410 can comprise two or more processors, where the two or more processors can include homogeneous processors, heterogeneous processors, etc. In the block diagram, the multicore processor can include N processor cores such as core 0 420, core 1 440, core N−1 460, and so on. Each processor can comprise one or more elements. In one or more implementations, each core, including cores 0 through core N−1, can include a physical memory protection (PMP) element, such as PMP 422 for core 0; PMP 442 for core 1, and PMP 462 for core N−1. In a processor architecture such as the RISC-V™ architecture, a PMP can enable processor firmware to specify one or more regions of physical memory such as cache memory of the shared memory, and to control permissions to access the regions of physical memory. The cores can include a memory management unit (MMU) such as MMU 424 for core 0, MMU 444 for core 1, and MMU 464 for core N−1. The memory management units can translate virtual addresses used by software running on the cores to physical memory addresses with caches, the shared memory system, etc.

The processor cores associated with the multicore processor 410 can include caches such as instruction caches and data caches. The caches, which can comprise level 1 (L1) caches, can include an amount of storage such as 16 KB, 32 KB, and so on. The caches can include an instruction cache I$ 426 and a data cache D$ 428 associated with core 0; an instruction cache I$ 446 and a data cache D$ 448 associated with core 1; and an instruction cache I$ 466 and a data cache D$ 468 associated with core N−1. In addition to the level 1 instruction and data caches, each core can include a level 2 (L2) cache. The level 2 caches can include L2 cache 430 associated with core 0; L2 cache 450 associated with core 1; and L2 cache 470 associated with core N−1. The cores associated with the multicore processor 410 can include further components or elements. The further elements can include a level 3 (L3) cache 412. The level 3 cache, which can be larger than the level 1 instruction and data caches, and the level 2 caches associated with each core, can be shared among all of the cores. The further elements can be shared among the cores. In one or more implementations, the further elements can include a platform level interrupt controller (PLIC) 414. The platform-level interrupt controller can support interrupt priorities, where the interrupt priorities can be assigned to each interrupt source. The PLIC source can be assigned a priority by writing a priority value to a memory-mapped priority register associated with the interrupt source. The PLIC can be associated with an advanced core local interrupter (ACLINT). The ACLINT can support memory-mapped devices that can provide inter-processor functionalities such as interrupt and timer functionalities. The inter-processor interrupt and timer functionalities can be provided for each processor. The further elements can include a joint test action group (JTAG) element 416. The JTAG can provide a boundary within the cores of the multicore processor. The JTAG can enable fault information to a high precision. The high-precision fault information can be critical to rapid fault detection and repair.

The multicore processor 410 can include one or more interface elements 418. The interface elements can support standard processor interfaces including an Advanced extensible Interface (AXI™) such as AXI4™, an ARM™ Advanced extensible Interface (AXI™) Coherence Extensions (ACE™) interface, an Advanced Microcontroller Bus Architecture (AMBA™) Coherence Hub Interface (CHI™), etc. In the block diagram 400, the interface elements can be coupled to the interconnect. The interconnect can include a bus, a network, and so on. The interconnect can include an AXI™ interconnect 480. In one or more implementations, the network can include network-on-chip functionality. The AXI™ interconnect can be used to connect memory-mapped “master” or boss devices to one or more “slave” or worker devices. In the block diagram 400, the AXI interconnect can provide connectivity between the multicore processor 410 and one or more peripherals 490. The one or more peripherals can include storage devices, networking devices, and so on. The peripherals can enable communication using the AXI™ interconnect by supporting standards such as AMBA™ version 4, among other standards.

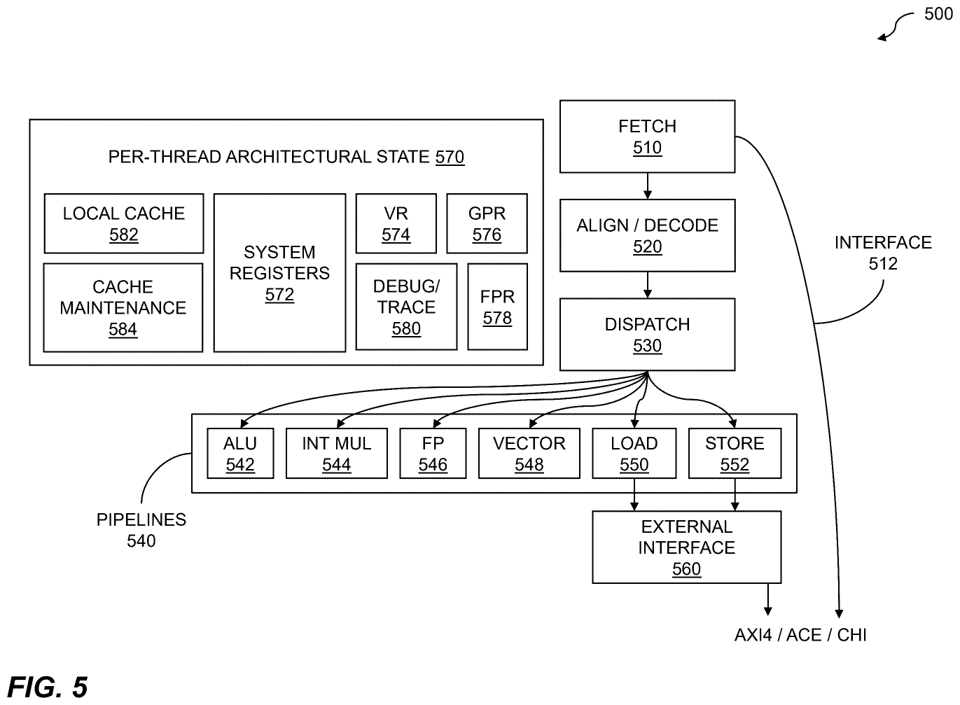

FIG. 5 is a block diagram of a pipeline. One or more pipelines associated with a processor architecture can be used to greatly enhance processing throughput. The processor architecture can be associated with one or more processor cores. The processing throughput can be increased because multiple operations can be executed in parallel. In one or more implementations, a processor core is accessed. The processor core is coupled to a memory hierarchy, and the processor core is configured to execute vector operations, scalar operations, and vector load micro-operations and vector store micro-operations. A decode unit decodes a vector memory operation, where the vector memory operation is associated with a unit stride addressing mode. The decoding includes dividing the vector memory operation into one or more vector memory micro-operations. A dispatch unit sends at least one vector micro-operation within the one or more vector micro-operations to a scalar request queue within a plurality of request queues. A load-store unit within the processor core issues the at least one vector micro-operation. The issuing includes selecting, from the plurality of request queues, the at least one vector memory micro-operation.

The blocks within the block diagram can be configurable in order to provide varying processing levels. The varying processing levels can be based on processing speed, bit lengths, word lengths, numbers of micro-operations, and so on. The block diagram 500 can include a fetch block 510. The fetch block 510 can read a number of bytes from a cache such as an instruction cache (not shown). The number of bytes that are read can include 16 bytes, 32 bytes, 64 bytes, and so on. The fetch block can include branch prediction techniques, where the choice of branch prediction technique can enable various branch predictor configurations. The fetch block can access memory through an interface 512. The interface can include a standard interface such as one or more industry standard interfaces. The interfaces can include an Advanced extensible Interface (AXI™), an ARM™ Advanced extensible Interface (AXI™) Coherence Extensions (ACE™) interface, an Advanced Microcontroller Bus Architecture (AMBA™) Coherence Hub Interface (CHI™), etc.

The block diagram 500 includes an align and decode block 520. Operations such as data processing operations can be provided to the align and decode block by the fetch block. The align and decode block can partition a stream of operations provided by the fetch block. The stream of operations can include operations of differing bit lengths, such as 16 bits, 32 bits, and so on. The align and decode block can partition the fetch stream data into individual operations. The operations can be decoded by the align and decode block to generate decoded packets. The decoded packets can be used in the pipeline to manage execution of operations. The block diagram 500 can include a dispatch block 530. The dispatch block can receive decoded instruction packets from the align and decode block. The decoded instruction packets can be used to control a pipeline 540, where the pipeline can include an in-order pipeline, an out-of-order (OoO) pipeline, etc. In one or more exemplary implementations, the processor core executes one or more instructions out of order. A pipeline can be associated with the one or more execution units. The pipelines associated with the execution units can include processor cores, arithmetic logic unit (ALU) pipelines 542, integer multiplier pipelines 544, floating-point unit (FPU) pipelines 546, vector unit (VU) pipelines 548, and so on. The dispatch unit can further dispatch instructions to pipelines that can include load pipelines 550, and store pipelines 552. The load pipelines and the store pipelines can access storage such as the common memory using an external interface 560. The external interface can be based on one or more interface standards such as the Advanced extensible Interface (AXI™). Following execution of the instructions, further instructions can update the register state. Other operations can be performed based on actions that can be associated with a particular architecture. The actions that can be performed can include executing instructions to update the system register state, trigger one or more exceptions, and so on.

In one or more exemplary implementations, the plurality of processors can be configured to support multi-threading. The system block diagram can include a per-thread architectural state block 570. The inclusion of the per-thread architectural state can be based on a configuration or architecture that can support multi-threading. In one or more exemplary implementations, thread selection logic can be included in the fetch and dispatch blocks discussed above. The per-thread architectural state can include system registers 572. The system registers can be associated with individual processors, a system comprising multiple processors, and so on. The system registers can include exception and interrupt components, counters, etc. The per-thread architectural state can include further registers such as vector registers (VRs) 574. The vector registers can be grouped in a vector register file and can be used for vector operations. In one or more exemplary implementations, the width of the vector register file is 512 bits. Additional registers, such as general-purpose registers (GPRs) 576 and floating-point registers (FPRs) 578, can be included. These registers can be used for general purpose (e.g., integer) operations, and floating-point operations, respectively. The per-thread architectural state can include a debug and trace block 580. The debug and trace block can enable debug and trace operations to support code development, troubleshooting, and so on. In one or more exemplary implementations, an external debugger can communicate with a processor through a debugging interface such as a joint test action group (JTAG) interface. The per-thread architectural state can include a local cache state 582. The architectural state can include one or more states associated with a local cache such as a local cache coupled to a grouping of two or more processors. The local cache state can include clean or dirty, zeroed, flushed, invalid, and so on. The per-thread architectural state can include a cache maintenance state 584. The cache maintenance state can include maintenance needed, maintenance pending, and maintenance complete states, etc.

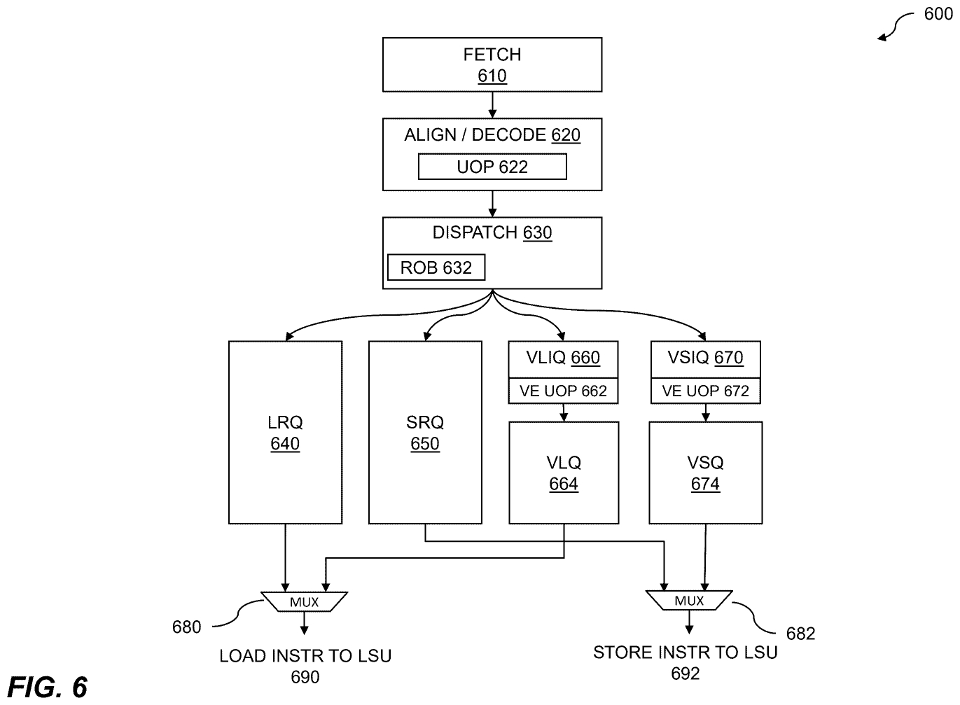

FIG. 6 is a block diagram for dispatching instructions. Instructions such as vector memory instructions based on one or more strides, scalar memory instructions, and so on can be fetched from storage. The vector memory instructions can include vector memory instructions based on an indexed stride or a constant stride. The vector memory instructions can include vector memory instructions based on a unit stride. In embodiments, the storage can include a memory, an instruction queue, and so on. The instructions can be decoded. Vector memory instructions that are based on a unit stride can be divided into one or more micro-operations. The micro-operations can be sent by a dispatch unit to a scalar request queue. The micro-operations can be issued to a load-store unit, where the load-store unit can handle memory access operations such as memory load operations and memory store operations. The dispatching instructions enables non-blocking unit stride vector instruction dispatch with micro-operations.

The block diagram 600 includes a fetch unit 610. In one or more examples, the fetch unit can perform functions such as retrieving the next instruction from memory based on a program counter (PC). The fetch unit may also perform functions that include incrementing the PC to point to the next instruction. In one or more examples, the fetch unit can also participate in branch prediction to improve instruction flow efficiency. Additionally, the fetch unit can interact with one or more instruction caches to reduce latency when fetching instructions. In one or more examples, the fetch unit may be similar to fetch block 510 shown in FIG. 5 above. Once instructions are fetched, the instructions are provided to the align/decode unit 620. The align/decode unit may perform functions that include aligning instruction boundaries to ensure proper processing. In one or more examples, the aligning is based on a unit stride. In embodiments, the unit stride can denote edges of data elements. The decoding by the align/decode unit can include dividing an instruction such as a vector memory instruction based on a unit stride into one or more vector memory micro-operations 622. Additionally, the align/decode unit can perform operations of translating binary instruction codes into control signals and fields needed for execution, and also identifying and retrieving operands from registers based on the instruction. The operands can include, but are not limited to, register operands, immediate operands (to support constants embedded directly within the instruction), memory operands, PC-relative operands (addresses calculated relative to the current value of the program counter, often used for branching), indexed operands, and/or other types of operands. In one or more examples, the align/decode unit may be similar to the align/decode block 520 shown in FIG. 5.

Once the scalar operations and the vector memory instructions, such as instructions based on a unit stride, are decoded into micro-operations, the scalar instructions and the micro-operations can be provided to the dispatch unit 630. Vector memory instructions based on other stride types can also be broken up into micro-operations by the micro-operation sequencer to be provided to the dispatch unit. In one or more examples, the dispatch unit can perform functions that include sending at least one vector micro-operation, within the one or more vector micro-operations, to a scalar request queue within a plurality of request queues. In embodiments, the scalar request queue can include a load request queue (LRQ) (discussed below). The dispatch unit can include a reorder buffer (ROB) 632. In one or more examples, the ROB can keep track of the order of micro-operations as they are issued and executed out of order. The ROB can enable proper micro-operations retirement by ensuring that micro-operations such as memory loads and memory stores are completed and that the loads and the stores are performed in the correct program order. The ROB can include multiple entries, where each entry corresponds to an instruction in the dispatch unit. A reorder buffer identification (ROBID) can refer to an entry in the ROB.

Based on the instruction type, such as a vector operation or a scalar operation, the dispatch unit can send one or more micro-operations to one of various queues for further processing. Recall that the dispatch unit can send one or more vector memory micro-operations based on an indexed stride or a constant stride to a first vector input queue. When the vector operation is a load, the first vector input queue can comprise a vector load input queue (VLIQ) 660. The vector element micro-operation sequencer 662 within the VLIQ can split the one or more vector load micro-operations into one or more vector element load micro-operations. The one or more vector element load micro-operations can then be chosen to be sent to an LSU for execution. The above can also apply to a vector store instruction. When the vector operation is a store operation, the first vector input queue can comprise a vector store input queue (VSIQ) 670. The vector element micro-operation sequencer 672 within the VSIQ can split the one or more vector store micro-operations into one or more vector element store micro-operations. The one or more vector element store micro-operations can then be chosen to be sent to an LSU for execution.

In one or more examples, the vector element micro-operation sequencer (whether within the VLIQ or the VSIQ) can be implemented as a finite state machine, which takes inputs that can include a type register, a source register, and/or a destination register. The vector element micro-operation sequencer logic can ensure that it increments source register(s), destination register(s), element numbers, and so on as per requirement of the processor vector specification when it breaks the instruction into individual vector element micro-operations. The processor vector specification can include a RISC-V vector specification. In one or more examples, the splitting, the executing, and the determining are performed by a micro-operation sequencer that is separate from a dispatch unit of the processor core. An important benefit of the vector instruction input queues (VLIQ and VSIQ) is that they alleviate the need for the dispatch unit to further split vector micro-operations into additional vector element micro-operations, which could potentially cause stalls in execution of other instructions waiting to be dispatched, such as a scalar load, scalar store, or another vector memory operation or micro-operation.

Recall that the processor can include a plurality of memory queues. The memory queues can send instructions to a mux which can select between queue outputs. The output of the mux can be sent directly to an execution unit, such as a load-store unit (LSU). In embodiments, the plurality of memory queues includes a scalar load request queue (LRQ) 640. The LRQ can process scalar load instructions, micro-operations divided from vector load operations based on a unit stride, etc. In embodiments, the plurality of memory queues includes a scalar store request queue (SRQ) 650. The SRQ can process scalar store instructions and vector store micro-operations divided from vector store operations based on unit stride, etc. In embodiments, the plurality of memory queues includes a vector load queue (VLQ) 664. The VLQ can process vector load element micro-operations divided from vector load micro-operations based on an index stride, constant stride, etc. In embodiments, the plurality of memory queues includes a vector store queue (VSQ) 674. The VSQ can process vector store element micro-operations divided from vector store micro-operations based on an index stride, constant stride, etc.

With the above structure, a load operation can be selected from the LRQ or the VLQ using a mux and can be sent to the load-store unit for execution. Likewise, a store operation can be selected from the SRQ or the VSQ using a mux and can be sent to the load-store unit for execution. The load operations and store operations are routed to respective muxes. In one or more exemplary implementations, the muxes may be operated by selecting one of two input signals to pass through to the output based on a control signal. Thus, the multiplexers route one of the two inputs to the output depending on the value of the control signal, enabling flexible data routing for scalar and vector memory instructions in exemplary implementations.

The load operations (both scalar and vector) are routed to mux 680. Similarly, the store operations (both scalar and vector) are routed to mux 682. The muxes pass instructions to respective load store units. Mux 680 is configured to select between scalar load instructions from the LRQ and vector load instructions from the VLQ. The load instruction 690 output of the mux 680 is sent to a load-store unit. Similarly, mux 682 is configured to select between scalar store instructions from the SRQ and vector store instructions from the VSQ. The store instruction 692 output of the mux 682 can be sent to a load-store unit. The ROBID can be used as a criterion for configuring the muxes to select the proper scalar or vector instruction to issue an oldest instruction to an execution pipeline. Mux 680 can be configured to provide the proper load instruction to the load store unit based on the ROBID. Similarly, mux 682 can be configured to provide the proper store instruction to the load store unit based on the ROBID.

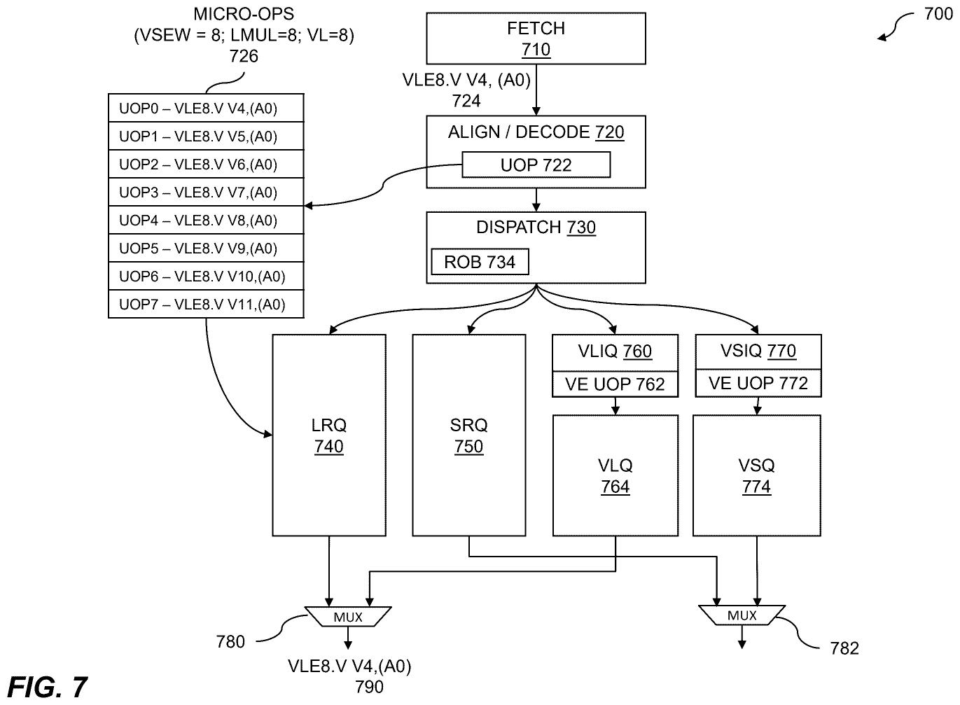

FIG. 7 is an example of dispatching vector and scalar operations. The vector instructions and the scaler instructions can be dispatched for execution on one or more processors. The dispatching can be based on a type of memory access stride such as a unit stride, an index stride, or a constant stride. The dispatching of instructions is enabled by non-blocking unit stride vector instruction dispatch with micro-operations. The example 700 includes a fetch unit 710. In one or more examples, the fetch unit 710 can perform functions such as retrieving the next instruction from memory based on a program counter (PC). The fetch unit can also perform functions that include incrementing the PC to point to the next instruction. In one or more examples, the fetch unit can also participate in branch prediction to improve instruction flow efficiency. Additionally, the fetch unit may interact with one or more instruction caches before accessing memory in order to reduce latency when fetching instructions. In one or more examples, the fetch unit may be similar to fetch block 510 shown in FIG. 5. Once instructions are fetched, the instructions are provided to the align/decode unit 720. The align/decode unit may perform functions that include aligning instruction boundaries to ensure proper processing. Additionally, the align/decode unit can perform operations of translating binary instruction codes into control signals and control fields needed for execution and can also identify and retrieve operands from registers based on the instruction. Noted previously and throughout, a vector memory operation can be divided into micro-operations. In the example 700, the decode unit can divide the vector memory operation into one or more vector memory micro-operations 722. An example instruction to be divided into micro-operations is shown. In this case, the instruction is VLE8.V 724. The “8” in the instruction can be called an encoding width. Thus, the instruction can indicate an element width. This value can be compared to other control values to determine how many micro-operations are generated by the micro-operation sequencer. The micro-operations that result from the dividing of example instructions are shown in 726, along with control values that can control the micro sequencer. In this case, VSEW indicates an element width of 8 bits. The encoding width can be divided by the VSEW, resulting in a value of 1. This value can be used in combination with LMUL (which can indicate a vector multiplier of eight) to determine how many micro-operations should be generated. In this case, eight micro-operations were generated with incrementing destination registers starting at V4. Once decoded, instructions and/or micro-operations can be provided to the dispatch unit 730. The micro-operations can include one or more micro-operations that were divided from a vector load instruction. The micro-operations can be associated with a stride such as a unit stride, index stride, constant stride, and so on.

In a usage example, a micro-operation created by the micro-operation sequencer and sent to dispatch can be associated with an index stride or a constant stride addressing mode. In this case, if the vector micro-operation is a load, it can be sent to the VLIQ 760 where it can be further divided into one or more vector element micro-operations by vector element micro-sequencer 762. The resulting vector element load micro-operations can be sent to the VLQ 764. If the vector micro-operation is a store, it can be sent to the VSIQ 770 where it can be further divided into one or more vector element micro-operations by vector element micro-sequencer 772. The resulting vector element store micro-operations can be sent to the VSQ 774.

In the example 700, the vector instruction is associated with a unit stride addressing mode. Thus, the micro-operations shown at 726 can be sent to a load request queue (LRQ) 740 (since the original instruction was based on a vector load). One or more scalar load instructions can also be sent to the LRQ. A vector store instruction can be divided into vector store micro-operations and sent to the store request queue (SRQ) shown at 750. One or more scalar store instructions can also be sent to the SRQ. In one or more examples, the ROB 734 can keep track of the order of instructions or the micro-operations as they are issued and executed out of order. The ROB can enable proper instruction retirement by ensuring that instructions are completed and that results are written back in the correct program order. The ROB can include multiple entries, where each entry corresponds to an instruction, operation, micro-operation, etc. in the dispatch unit. A reorder buffer identification (ROBID) can refer to an entry in the ROB. In embodiments, the ROBID can indicate an oldest instruction within the plurality of request queues.

One or more scalar load instructions and/or one or more micro-operations associated with a vector load instruction with a unit stride can be routed to the LRQ. Mux 780 can select between an entry in the LRQ and vector load element micro-operation in the VLQ 764. Likewise, one or more scalar store instructions and/or one or more micro-operations associated with a vector store instruction with a unit stride can be routed to the SRQ. Mux 782 can select between an entry in the SRQ and vector store element micro-operation in the VSQ 774. The selecting can be based on the oldest operation. In the example of FIG. 7, the vector load micro-operation VLE8.V V4, (A0) 790 can have the oldest ROBID, and thus it can be selected by mux 780 to be sent to a load-store unit for execution. Once the micro-operation is retired, the ROBID can be cleared.

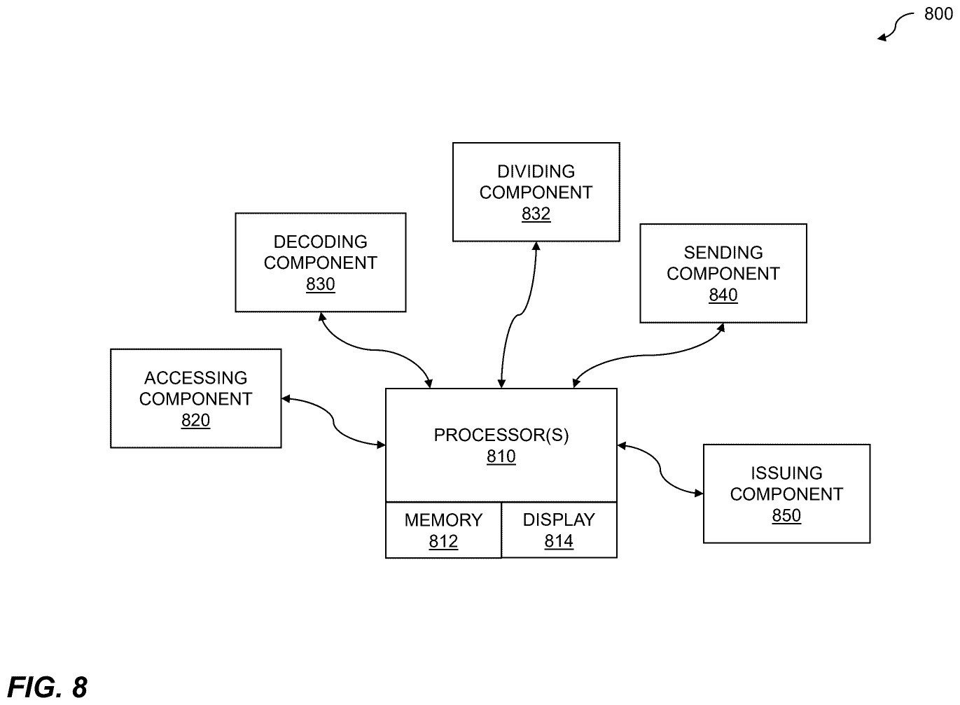

FIG. 8 is a system diagram for non-blocking unit stride vector instruction dispatch with micro-operations. The system 800 can include instructions and/or functions for design and implementation of integrated circuits that support vector processing for non-blocking unit stride vector instruction dispatch with micro-operations. The system 800 can include instructions and/or functions for generation and/or manipulation of design data such as hardware description language (HDL) constructs for specifying structure and operation of an integrated circuit. The system 800 can further perform operations to generate and manipulate Register Level Transfer (RTL) abstractions. These abstractions can include parameterized inputs that enable specifying elements of a design such as a number of elements, sizes of various bit fields, and so on. The parameterized inputs can be input to a logic synthesis tool which in turn creates the semiconductor logic that includes the gate-level abstraction of the design that is used for fabrication of integrated circuit (IC) devices.

The system can include one or more of processors, memories, cache memories, displays, and so on. The system 800 can include one or more processors 810. The processors can include standalone processors, processors within integrated circuits or chips, processor cores in field-programmable gate arrays (FPGAs) or application-specific integrated circuits (ASICs), and so on. The one or more processors 810 are coupled to a memory 812, which stores instructions. The memory can include one or more of local memory, cache memory, system memory, etc. The system 800 can further include a display 814 coupled to the one or more processors 810. The display 814 can be used for displaying data, instructions, operations, micro-operations, and the like. The operations can include instructions and functions for implementation of integrated circuits, including processor cores. In exemplary implementations, the processor cores can include RISC-V™ processor cores. A system comprising the one or more processors 810, when executing the instructions which are stored in the memory 812, is configured to enable non-blocking unit stride vector instruction dispatch with micro-operations.

The system 800 can include an accessing component 820. The accessing component 820 can include functions and instructions for accessing a processor core, wherein the processor core is coupled to a memory hierarchy, and wherein the processor core is configured to execute vector operations, scalar operations, and micro-operations. The processor core can include an ARM core, a MIPS core, and/or other suitable core type. In one or more exemplary implementations, the processor core can include a RISC-V architecture. The processor core can support vector operations. The RISC-V architecture can include extensions, where the extensions can enable execution of various arithmetic and logic operations. In exemplary implementations, a RISC-V architecture can include vector extensions. In exemplary implementations, the vector extensions can include ELEN, VLEN, SEW, LMUL, VLMAX, VL, and VSTART components. The processor core includes an execution pipeline, where the execution pipeline is configured to execute micro-operations. The micro-operations can include accessing a vector register, a starting address for data, a source register, a destination register, and so on.

The system 800 can include a decoding component 830. The decoding component 830 can include functions and instructions for decoding, by a decode unit, a vector memory operation, wherein the vector memory operation is associated with a unit stride addressing mode. The decoding can include translating binary instruction codes into control signals and control fields needed for execution and can also identify and retrieve operands from registers based on the instruction. The system 800 can include a dividing component 832. The dividing component can include functions and instructions for dividing the vector memory operation into one or more vector memory micro-operations. Recall that the vector memory operation that was decoded was based on a vector memory operation associated with a unit stride addressing mode. As a result, the micro-operations that were divided from the memory vector operation can be executed as scalar memory operations. In embodiments, the dividing can be based on a destination register. The destination register can be a register within a processor core, a multiprocessor core, and so on. In embodiments, the vector memory operation can include a vector load operation. The vector load operation can be based on a unit stride. The memory operation can include a vector store operation. The vector store operation can be based on a unit stride.

The system 800 can include a sending component 840. The sending component 840 can include functions and instructions for sending, by the dispatch unit, at least one vector micro-operation within the one or more vector micro-operations, to a scalar request queue within a plurality of request queues. The one or more micro-operations can be sent individually, as a block, and so on. The one or more micro-operations can be interspersed with one or more scalar memory operations. The sending of a vector memory instruction is based on the memory addressing mode associated with the vector memory operation. Discussed previously, a vector memory instruction based on a unit stride can be divided into micro-operations, and the micro-operations can be sent to a scalar load request queue or a scalar store request queue. When based on an indexed stride or a constant stride, the micro-operations can be sent to a vector load input queue or a vector store input queue for further processing.

The system 800 can include an issuing component 850. The issuing component 850 can include functions and instructions for issuing, to a load-store unit within the processor core, the at least one vector micro-operation, wherein the issuing includes selecting, from the plurality of request queues, the at least one vector memory micro-operation. The issuing can further include issuing a scalar operation, a vector operation based on an indexed stride or based on a constant stride, and so on. The memory operation can include a scalar memory operation and/or a vector memory operation. The scalar operations can include, but are not limited to, operations such as load word and store word, load byte and store byte, load byte unsigned and store byte unsigned, and/or other load instructions that support loading data from memory into a register, and/or storing data from a register into memory. Similarly, vector memory operations can include loading vector element values from memory into registers and/or storing vector element values from registers into memory.

The system 800 can include a computer program product embodied in a non-transitory computer readable medium for vector processing, the computer program product comprising code which causes one or more processors to generate semiconductor logic for: accessing a processor core, wherein the processor core is coupled to a memory hierarchy, and wherein the processor core is configured to execute vector operations, scalar operations, and micro-operations; decoding, by a decode unit, a vector memory operation, wherein the vector memory operation is associated with a unit stride addressing mode, wherein the decoding includes dividing the vector memory operation into one or more vector memory micro-operations; sending, by a dispatch unit, at least one vector micro-operation within the one or more vector micro-operations, to a scalar request queue within a plurality of request queues; and issuing, to a load-store unit within the processor core, the at least one vector micro-operation, wherein the issuing includes selecting, from the plurality of request queues, the at least one vector memory micro-operation.

The system 800 can include a computer system for vector processing comprising: a memory which stores instructions; one or more processors coupled to the memory, wherein the one or more processors, when executing the instructions which are stored, are configured to: access a processor core, wherein the processor core is coupled to a memory hierarchy, and wherein the processor core is configured to execute vector operations, scalar operations, and micro-operations; decode, by a decode unit, a vector memory operation, wherein the vector memory operation is associated with a unit stride addressing mode, wherein the decoding includes dividing the vector memory operation into one or more vector memory micro-operations; send, by a dispatch unit, at least one vector micro-operation within the one or more vector micro-operations, to a scalar request queue within a plurality of request queues; and issue, to a load-store unit within the processor core, the at least one vector micro-operation, wherein the issuing includes selecting, from the plurality of request queues, the at least one vector memory micro-operation.

As can now be appreciated, exemplary implementations can improve processor performance by enabling out-of-order execution and the improved resource utilization that out-of-order execution provides, while mitigating the bottlenecks and performance hits that could occur when non-blocking unit stride vector operations are intermixed with scalar operations in an instruction pipeline. A decode unit decodes a vector memory operation, where the vector memory operation is associated with a unit stride addressing mode. The decoding includes dividing the vector memory operation into one or more vector memory micro-operations. At least one vector micro-operation within the one or more vector micro-operations is sent by a dispatch unit to a scalar request queue within a plurality of request queues. The dispatch unit is then available to process subsequent scalar operations. In this way, exemplary implementations can enable independent scheduling and execution, enhancing performance for diverse workloads, and resulting in more efficient processing and better utilization of processor capabilities.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagram and flow diagram illustrations depict methods, apparatus, systems, and computer program products. The elements and combinations of elements in the block diagrams and flow diagrams show functions, steps, or groups of steps of the methods, apparatus, systems, computer program products and/or computer-implemented methods. Any and all such functions-generally referred to herein as a “circuit,” “module,” or “system”—may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM); an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States, then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A processor-implemented method for vector processing comprising:
accessing a processor core, wherein the processor core is coupled to a memory hierarchy, and wherein the processor core is configured to execute vector operations, scalar operations, and micro-operations;
decoding, by a decode unit, a vector memory operation, wherein the vector memory operation is associated with a unit stride addressing mode, wherein the decoding includes dividing the vector memory operation into one or more vector memory micro-operations;
sending, by a dispatch unit, at least one vector micro-operation within the one or more vector micro-operations, to a scalar request queue within a plurality of request queues; and
issuing, to a load-store unit within the processor core, the at least one vector micro-operation, wherein the issuing includes selecting, from the plurality of request queues, the at least one vector memory micro-operation.

2. The method of claim 1 wherein the dividing is based on a destination register.

3. The method of claim 1 wherein the vector memory operation comprises a vector load operation.

4. The method of claim 3 wherein the scalar request queue comprises a load request queue (LRQ).

5. The method of claim 4 wherein the plurality of request queues includes a vector load queue (VLQ).

6. The method of claim 5 wherein the selecting comprises choosing between a vector load operation within the VLQ and the at least one vector memory micro-operation within the LRQ.

7. The method of claim 6 wherein the vector load operation within the VLQ comprises a load of a single vector element.

8. The method of claim 6 wherein the choosing is based on a reorder buffer identification (ROBID).

9. The method of claim 8 wherein the ROBID indicates an oldest instruction within the plurality of request queues.

10. The method of claim 8 wherein the ROBID rolls over to zero on the next increment when it reaches a maximum value.

11. The method of claim 1 wherein the vector memory operation comprises a vector store instruction.

12. The method of claim 11 wherein the scalar request queue comprises a store request queue (SRQ).

13. The method of claim 12 wherein the plurality of request queues includes a vector store request queue (VSQ).

14. The method of claim 13 wherein the selecting comprises choosing between a vector store operation within the VSQ and the at least one vector memory micro-operation within the SRQ.

15. The method of claim 14 wherein the vector store operation within the VSQ comprises a store of a single vector element.

16. The method of claim 14 wherein the choosing is based on a reorder buffer identification (ROBID).

17. The method of claim 16 wherein the ROBID indicates an oldest instruction within the plurality of request queues.

18. The method of claim 16 wherein the ROBID rolls over to zero on the next increment when it reaches a maximum value.

19. The method of claim 1 wherein the dividing is accomplished by a micro-operation sequencer.

20. A computer program product embodied in a non-transitory computer readable medium for vector processing, the computer program product comprising code which causes one or more processors to generate semiconductor logic for:
accessing a processor core, wherein the processor core is coupled to a memory hierarchy, and wherein the processor core is configured to execute vector operations, scalar operations, and micro-operations;
decoding, by a decode unit, a vector memory operation, wherein the vector memory operation is associated with a unit stride addressing mode, wherein the decoding includes dividing the vector memory operation into one or more vector memory micro-operations;
sending, by a dispatch unit, at least one vector micro-operation within the one or more vector micro-operations, to a scalar request queue within a plurality of request queues; and
issuing, to a load-store unit within the processor core, the at least one vector micro-operation, wherein the issuing includes selecting, from the plurality of request queues, the at least one vector memory micro-operation.

21. A computer system for vector processing comprising:
a memory which stores instructions;
one or more processors coupled to the memory, wherein the one or more processors, when executing the instructions which are stored, are configured to:
access a processor core, wherein the processor core is coupled to a memory hierarchy, and wherein the processor core is configured to execute vector operations, scalar operations, and micro-operations;
decode, by a decode unit, a vector memory operation, wherein the vector memory operation is associated with a unit stride addressing mode, wherein the decoding includes dividing the vector memory operation into one or more vector memory micro-operations;
send, by a dispatch unit, at least one vector micro-operation within the one or more vector micro-operations, to a scalar request queue within a plurality of request queues; and
issue, to a load-store unit within the processor core, the at least one vector micro-operation, wherein the issuing includes selecting, from the plurality of request queues, the at least one vector memory micro-operation.
